(19) United States
(12) Patent Application Publication
(10) Pub. No.: US 2017/0096827 A1
(43) Pub. Date: Apr. 6, 2017

(54) APPARATUS, SYSTEM, AND METHOD FOR AUTOMATED POOL CLEANING

(71) Applicant: Larry Andrew Coaker, Saraland, AL (US)

(72) Inventor: Larry Andrew Coaker, Saraland, AL (US)

(21) Appl. No.: 15/280,856

(22) Filed: Sep. 29, 2016

Related U.S. Application Data
(60) Provisional application No. 62/235,848, filed on Oct. 1, 2015.

(51) Int. Cl. E04H 4/16; F16L 33/24; F16L 3/12

(52) U.S. Cl. CPC E04H 4/1654; F16L 3/12; F16L 33/24

(57) ABSTRACT

A hose adapter for use in an automated pool cleaning system is provided. The adapter attaches at one end to the outlet of a dedicated water return line in a swimming pool and at an opposite end to a pool cleaner hose. The adapter has an extension arm that secures the hose at an elevated position above the water return line. By elevating the hose, the adapter prevents kinking and tangling in the hose so that the automated cleaning system operates more effectively.

### CROSS REFERENCES

This application claims priority to U.S. Provisional Patent Application No. 62/235,848, filed on Oct. 1, 2015, which is incorporated herein by reference.

### FIELD OF THE INVENTION

The present invention refers generally to an apparatus, system, and method for automated pool cleaning.

### BACKGROUND

The bottoms and sides of swimming pools require regular cleaning to maintain a clean pool. In order to maintain a clean pool with minimal time and effort expended, pool owners often use automatic pool cleaners. Automatic pool cleaners used for cleaning the bottoms and sides of pools utilize a vacuum that sucks up debris, sediment, or any other dirt or foreign objects from the pool. The automatic pool cleaner has a means of locomotion so that it automatically moves around the bottom of the pool. The course taken by the cleaner may be a pre-determined course or a random course.

Some known automatic pool cleaners, such as suction-side cleaners and pressure-side cleaners, utilize the existing pumping system for pumping and filtering the pool water and thus must be connected to the pool's filter pump intake or discharge via a hose or tube. Suction-side cleaners utilize a hose that may be attached directly to the filter pump water intake or to a pool skimmer. Pressure-side cleaners utilize a hose attached directly to the filter pump water return line, which discharges high pressure water back into the pool. A pool typically has more than one return line, and a pressure-side cleaner hose is attached to one dedicated return line having a fitting, which typically comprises female threads, configured to connect the cleaner hose to the return line. The automatic cleaner uses the water pressure to create both locomotion and suction for the vacuum. A booster pump may optionally be used to provide higher pressure.

There are a number of problems associated with known automatic pool cleaners. One problem in particular is that the pool cleaner hose tends to get tangled and kinked as the automatic cleaner moves around the bottom or sides of the pool. Pool cleaner hoses typically have floats and swivels at various points along the length of the hose. The floats keep the majority of the hose floating on the water surface, and the swivels are intended to help prevent tangling by allowing segments of the hose to rotate. However, the swivels do not adequately prevent tangling of the hose. As the swivels age, the swivel connectors tend to become stiff and do not always allow the swivel to rotate freely, but even with brand new swivels the problem of tangling may still occur regularly.

One reason why a pool cleaner hose may become tangled is due to the configuration in which the hose is attached to the dedicated return line. Water return lines are typically located on the side wall of the pool from about one to four feet below the surface of the water. When the automatic cleaner moves in reverse or generally in a direction back toward the return line, the floating portion of the hose may be pushed back over a submerged portion, which may cause the hose to become kinked or looped up, thereby causing tangles in the hose. Typically, once the hose is tangled, the movement of the automatic cleaner will not automatically untangle it. Moreover, a kinked or tangled pool cleaner hose can significantly limit movement of the automatic cleaner or even cause the automatic cleaner to be lifted off the bottom of the pool. When this happens, the automatic pool cleaner does not clean the pool effectively, and the pool cleaner hose must then be disconnected and manually untangled before being reconnected to the return line and to the automatic cleaner before cleaning can recommence.

Accordingly, a need exists in the art for an apparatus that prevents a pool cleaner hose from becoming kinked or tangled while an automatic pool cleaner is in use. Furthermore, a need exists in the art for a pool cleaning system that can effectively clean a pool without the pool cleaner hose becoming kinked or tangled during use. Additionally, a need exists in the art for a method of using such a system to prevent a pool cleaner hose from kinking or tangling during use.

### SUMMARY

In one aspect, an adapter is provided for use with automatic pool cleaners in order to prevent pool cleaner hoses from becoming kinked or tangled during use. The adapter is configured for connecting a pool cleaner hose to a pool filter pump return line located below the water surface of a pool. The adapter has an extension arm configured to secure the hose in an elevated position above the connection point at the return line outlet. By elevating the hose, the adapter prevents a floating portion of the pool cleaner hose from being pushed back over a submerged portion of the hose during use, thereby reducing the occurrence of kinks or tangles in the pool cleaner hose during use.

The hose adapter comprises a fitting having a first end and a second end. The first end of the fitting is configured such that it can be attached to the outlet of a dedicated return line of a swimming pool, which is typically located on the side wall of the pool. The second end of the fitting is configured such that it can be attached to a pool cleaner hose. In a preferred embodiment, the fitting is an elbow fitting configured such that when the fitting is connected to a dedicated return line of a pool the second end of the fitting is generally facing upwards. The hose adapter further comprises an extension arm attached to the fitting and a hose clamp attached to the extension arm. When the fitting is connected to the return line, the extension arm extends generally in an upward direction. The extension arm may be curved as it extends away from the fitting. The extension arm and the hose clamp are configured to secure a portion of the pool cleaner hose in an elevated position above the return line to which the fitting is attached during use.

In another aspect, a system and method for automated pool cleaning is disclosed. The system comprises a pool hose adapter as described above, an automated pool cleaner, and a pool cleaner hose having a first end and a second end. To use the system, the hose adapter is attached to a pool's dedicated water return line. One end of the pool cleaner hose is then attached to the automated pool cleaner, and the opposite end of the hose is attached to the fitting of the hose adapter. Once the pool cleaner hose is connected to the fitting and the automated pool cleaner, a portion of the pool cleaner hose is secured to the extension arm of the hose adapter via one or more hose clamps. In a preferred embodiment, the extension arm holds the hose at or above the water surface. To begin cleaning the pool, a user initiates the automated pool cleaner to begin locomotion and suction for cleaning the pool. By utilizing the hose adapter in conjunction with the automated pool cleaner and hose, the automated pool cleaner can clean a pool while significantly reducing the occurrences of kinking or tangling of the pool cleaner hose, thereby making the pool cleaning process more convenient and efficient.

Additional features and advantages of the present disclosure will be set forth in the description which follows, and will be apparent from the description, or may be learned by practice of the present disclosure. The foregoing general description and following detailed description are exemplary and explanatory and are intended to provide further explanation of the present disclosure.

### DESCRIPTION OF THE DRAWINGS

These and other features, aspects, and advantages of the present disclosure will become better understood with regard to the following description, appended claims, and accompanying drawings where:

FIG. 1 shows an elevational view of an apparatus embodying features consistent with the principles of the present disclosure.

FIG. 2 shows a partial perspective view of an apparatus embodying features consistent with the principles of the present disclosure.

FIG. 3 shows a partial perspective view of an apparatus embodying features consistent with the principles of the present disclosure.

FIG. 4 shows an exploded view of an apparatus embodying features consistent with the principles of the present disclosure.

FIG. 5 shows a perspective view of an apparatus embodying features consistent with the principles of the present disclosure, said apparatus being used with a compatible pool return line and compatible pool cleaner hose.

FIG. 6 shows a perspective view of an apparatus embodying features consistent with the principles of the present disclosure, said apparatus being used with a compatible pool return line and compatible pool cleaner hose.

FIG. 7 shows a perspective view of a system embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

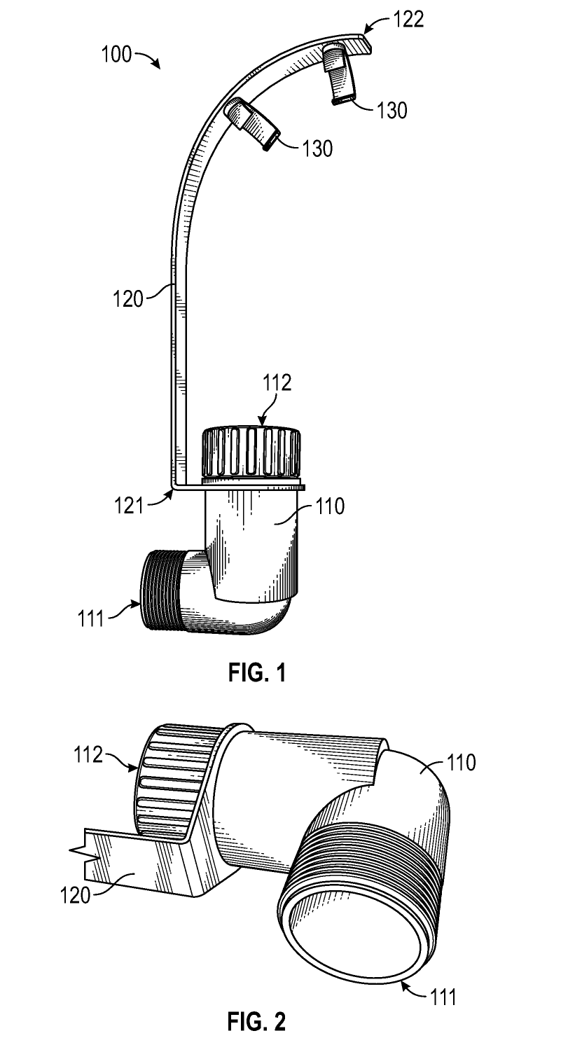

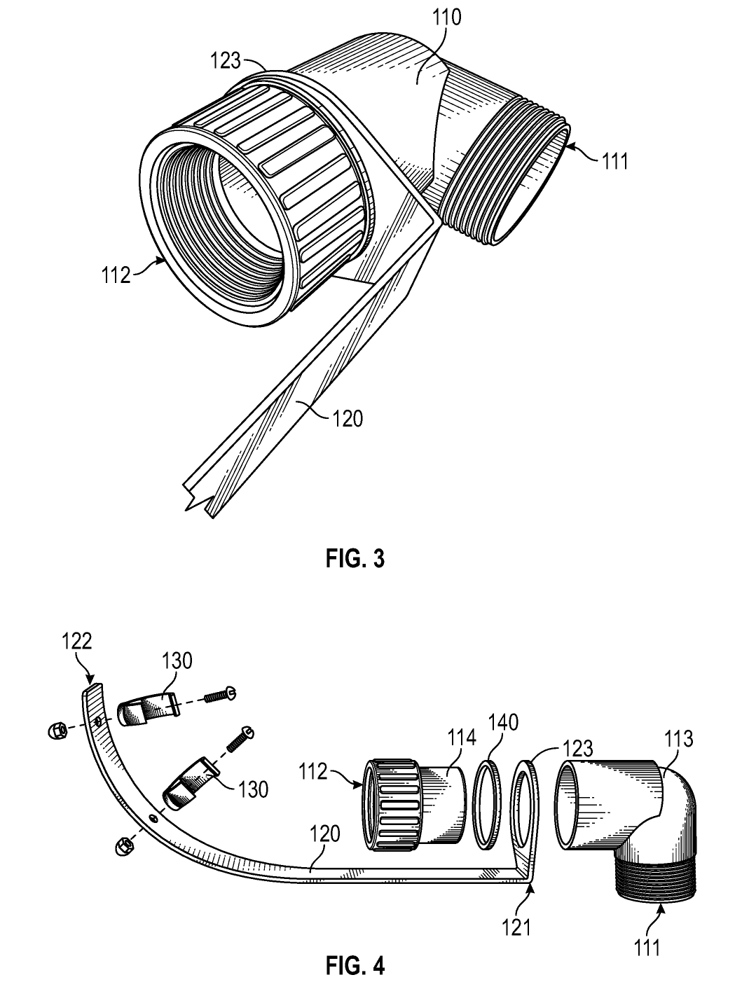

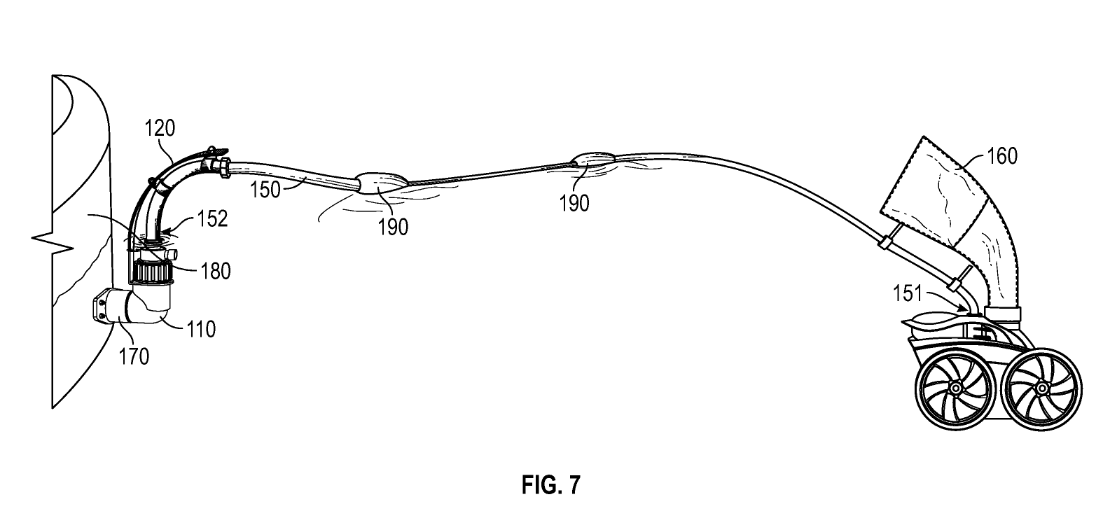

Turning now to the drawings, FIGS. 1-7 illustrate preferred embodiments of an apparatus and system for automated pool cleaning. In one aspect, a hose adapter 100 for use with automatic pool cleaners is provided. The adapter 100 is designed to prevent pool cleaner hoses from becoming kinked or tangled while an automatic pool cleaner is in use. The hose adapter 100 connects a pool cleaner hose 150 to the outlet of a pool filter pump return line 170 (“return line”) located beneath the surface of the water, typically on the side wall 180 of the pool. The adapter 100 has an extension arm 120 configured to secure the hose 150 in an elevated position above the connection point at the return line outlet 170. In a preferred embodiment, the extension arm 120 holds the hose 150 at or above the water surface. By elevating the hose 150, the adapter 100 prevents a floating portion of the pool cleaner hose 150 from being pushed back over a submerged portion of the hose during use, thereby reducing the occurrence of kinks or tangles in the pool cleaner hose during use. The floating portion of the hose remains floating due to floats 190 positioned at intervals along the length of the hose 150, as shown in FIGS. 6-7.

As illustrated in FIG. 1, the hose adapter 100 comprises a fitting 110, an extension arm 120 attached to the fitting 110, and one or more hose clamps 130 attached to the extension arm. The fitting 110 has a first end 111 and a second end 112. The first end 111 of the fitting 110 is configured such that it can be attached to the outlet of a return line 170 of a pool. The second end 112 of the fitting 110 is configured such that it can be attached to a pool cleaner hose 150. The extension arm 120 and the one or more hose clamps 130 of the hose adapter 100 are configured to secure a portion of a poll cleaner hose 150 above the return line 170 to which the fitting 110 is attached.

As illustrated in FIGS. 1-7, the fitting 110 is preferably an elbow fitting. Thus, the second end 112 of the fitting 110 is positioned at an angle to the first end 111. In a preferred embodiment, the fitting 110 of the hose adapter 100 is a 90-degree elbow fitting, as shown in FIG. 1. However, it is understood that the angle between the first end 111 and second end 112 of the fitting 110 may be varied. For instance, the fitting 110 may be a 45-degree elbow fitting, or any similar elbow fitting known with the art. In one preferred embodiment, the fitting 110 is made of polyvinyl chloride (PVC). However, it is understood that any suitable piping material may be used including, but not limited to, any suitable type of metal or plastic. In another preferred embodiment, the fitting 110 is schedule 40 pipe. In one preferred embodiment, as best seen in FIG. 3, the fitting 110 is a street elbow. Thus, the fitting 110 has male threads on the first end 111 and female threads on the second end 112 of the fitting 110.

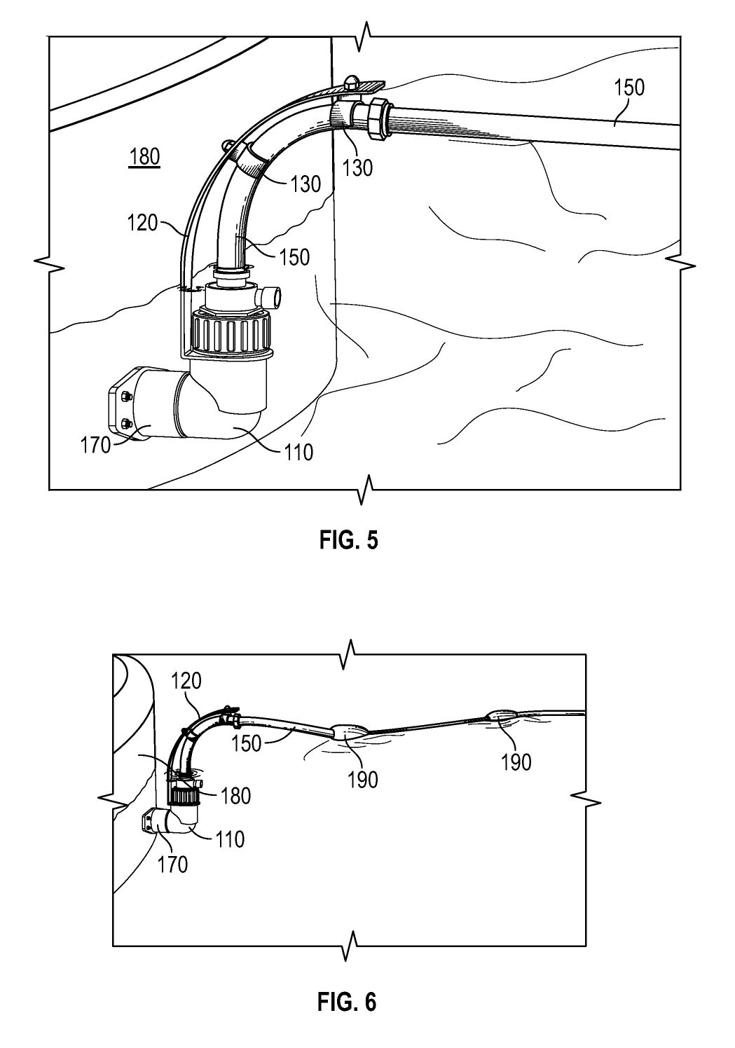

In a preferred embodiment, the first end 111 of the fitting 110 and the second end 112 of the fitting have an opening with a diameter of approximately 1.5 inches. Because existing pool return lines commonly have 1.5 inch diameter outlets with female threads and many commercially available pool cleaner hoses have 1.5 inch diameter inlets with male threads, it is generally preferable that the first end 111 of the fitting 110 has an opening of 1.5 inches in diameter with male threads and the second end 112 of the fitting 110 has an opening of 1.5 inches in diameter with female threads so that the adapter 100 is compatible with existing return lines and pool cleaner hoses. Thus, in accordance with one embodiment of the present disclosure, to install the adapter 100, the male threads on the first end 111 of the fitting 110 are threaded into female threads on the outlet of a pool's return line 170, and the male threads of a pool cleaner hose 150 are threaded into the female threads of the second end 112 of the fitting 110. When the hose adapter 100 is installed, the fitting 110 is preferably positioned such that the second end 112 of the fitting 110 is generally facing upwardly, as shown in FIGS. 5-7. It is understood that the present disclosure also contemplates embodiments wherein the first end 111 of the fitting 110 has female threads and the second end 112 of the fitting 110 has male threads.

It should be understood by one skilled in the art that the diameter of the opening on the first end 111 of the fitting 110 or the opening on the second end 112 of the fitting 110, or both, may be varied and still fall within the scope of the present disclosure. Furthermore, it should be understood by one skilled in the art that any fitting 110 having one end compatible with a pool's return line and an opposite end compatible with a pool cleaner hose falls within the scope of the present disclosure. Thus, although male and female threads are the preferred means for connecting the fitting 110 to the outlet of a pool's return line and to a pool cleaner hose, other connecting means may also be utilized. For instance, various types of “quick connectors” are known in the art and are commonly used for connecting hoses to various types of fittings, such as quick connectors used to connect common garden hoses to plumbing outlets. Such quick connectors may be incorporated into one end of the fitting 110 or both ends of the fitting 110 to connect the fitting 110 to a pool's return line, a pool cleaner hose, or both. Other connecting devices that may be utilized include, but are not limited to, clamps, nipples, or flanges fastened together using screws, bolts, or any other suitable type of fastener.

As illustrated in FIGS. 1 and 4-6, the extension arm 120 generally has a first end 121 and a second end 122. In a preferred embodiment, as shown in FIG. 1, the extension arm 120 curves as the arm extends toward the second end 122. Preferably, there is an approximately 90 degree curve in the extension arm 120. As illustrated in FIGS. 5 and 6, in such embodiments, the outermost end of the second end 122 of the extension arm 120 is substantially parallel to the water surface when the hose adapter 100 is installed. In embodiments wherein the fitting 110 is curved, it is preferable that the second end 122 of the extension arm 120 is curved in a direction opposite of the first end 111 of the fitting 110, as shown in FIGS. 1 and 4-6. When installed, the extension arm 110 preferably curves away from the side wall 180 of the pool. In a preferred embodiment, the extension arm 120 is a generally flat piece of metal. To prevent rust and corrosion, it is preferable that the extension arm 120 is made of stainless steel. However, it is understood that that the extension arm 120 may be made of any suitable material including, but not limited to, plastic, metal, or rubber.

In a preferred embodiment, the length of the extension arm 120 is adjustable to account for different swimming pools having return line outlets 170 at varying depths. In one such embodiment, the extension arm 120 may be partially or fully telescopic. In one embodiment, the extension arm 120 can adjust from a length of about six inches to a length of about two feet. In another embodiment, the extension arm can be adjusted from a length of about two feet to a length of about four feet or more.

Preferably, the extension arm 120 is attached to the second end 112 of the fitting 110. In one preferred embodiment, as best seen in FIG. 4, the first end 121 of the extension arm 120 has a closed ring 123 configured to fit around the exterior of the fitting 110. In such embodiments, the extension arm 120 is connected to the fitting 110 via the closed ring 123.

As illustrated in FIG. 4, in one preferred embodiment, the fitting 110 may comprise two separate parts. The first part 113 of the fitting 110 comprises the first end 111 of the fitting 110 having male threads and an opposite end without threads. The second part 114 of the fitting 110 comprises the second end 112 of the fitting 110 having female threads and an opposite end without threads. In such embodiments, the non-threaded ends of the first part 113 and second part 114 of the fitting 110 are compatible such that the first part 113 and second part 114 of the fitting 110 can be attached by inserting the non-threaded end of the second part 114 into the non-threaded end of the first part 113. To further secure the attachment between the first part 113 and the second part 114 of the fitting 110, an adhesive, such as PVC glue or a similar adhesive, may be applied before the non-threaded end of the second part 114 is inserted into the non-threaded end of the first part 113.

In embodiments wherein the first end 121 of the extension arm 120 has a closed ring 123, the extension arm 120 may be attached to the fitting 110 by placing the closed ring 123 between the first part 113 and second part 114 of the fitting 110. To secure the extension arm 120 to the fitting 110, the non-threaded end of the second part 114 of the fitting 110 passes through the opening of the closed ring 123 before the non-threaded end of the second part 114 of the fitting 110 is inserted into the non-threaded end of the first part 113 of the fitting 110. Once attached to the fitting 110, it is preferable that the extension arm 120 is secured in a fixed position. However, in alternative embodiments, the extension arm 120 may be attached to the fitting 110 such that the extension arm is able to rotate freely around the fitting 110. It is understood that the present disclosure contemplates both embodiments wherein the fitting 110 is a single part as well as embodiments wherein the fitting 110 and extension arm 120 are molded into a single part such that assembly of the extension arm 120 to the fitting 110 is not required.

To help secure the extension arm 120 in a fixed position, in a preferred embodiment, the hose adapter 100 further comprises a gasket 140 positioned around the fitting 110 adjacent to the closed ring 123 of the extension arm 120 when the hose adapter 100 is assembled. In a preferred embodiment, the gasket 140 is positioned around the exterior of the second part 114 of the fitting 110. The gasket 140 helps to prevent the closed ring 123 from rotating around the fitting 110, thereby keeping the extension arm 120 generally in a fixed position.

As shown in FIG. 4, the extension arm 120 preferably has one or more holes in the second end 122 of the arm 120. The holes are utilized for attaching the one or more hose clamps 130 to the extension arm 130 using bolts, nuts, or any similar fastener. As shown in FIGS. 1 and 4, the one or more hose clamps 130 attached to the extension arm 120 are preferably U-shaped clamps configured such that a pool cleaner hose 150 can be firmly pressed into each clamp in order to secure the pool cleaner hose within the one or more hose clamps 130. To ensure the pool cleaner hose 150 is secured, it is preferable that at least two hose clamps 130 be used. In such embodiments, it is preferable that the hose clamps are spaced at least three inches apart. To secure the pool cleaner hose to the highest point of the extension arm 120 when the hose adapter 100 is installed, it is preferable that the one or more hose clamps 130 are attached near the second end 122 of the extension arm 120. It should be understood that other suitable securing devices may be used to secure a pool cleaner hose to the extension arm 120 including, but not limited to, string, rope, cord, rubber bands, hook and loop tape (e.g., “Velcro”), U-bolts, hooks, straps, clips, buckles, magnets, or any similar securing device known in the art.

To use the hose adapter 100, the male threads on the first end 111 of the fitting 110 are threaded into the female threads of a return line 170 of a pool. The male threads on the first end 111 of the fitting are threaded into the return line until the connection is relatively tight, but the rotation of the fitting 110 is stopped at a point at which the second end 112 of the fitting 110 is generally facing upward, as shown in FIGS. 5-6. In this configuration, the extension arm 120 is in a generally vertical position as the extension arm 120 extends away from the fitting 110 in a direction parallel to the second end 112 of the fitting, and the extension arm 120 is curved in a direction opposite to the first end 111 of the fitting 110. The male threads of one end of a pool cleaner hose 150 are then threaded into the second end 112 of the fitting 110. The pool cleaner hose 150 is then secured to the extension arm 120 using the one or more hose clamps 130 such that a portion of the pool cleaner hose is secured to the extension arm 120 at an elevated position at or above the surface of the water in the pool, as shown in FIGS. 5-6. Because the hose 150 is secured at an elevated position near the side wall 180 of the pool, the floating portion of the pool cleaner hose 150 cannot be pushed back over a submerged portion of the pool cleaner hose during cleaning. Once the pool cleaner hose has been connected to the second end 112 of the fitting 110 and secured to the extension arm 120 via the one or more hose clamps 130, the opposite end of the pool cleaner hose is connected to an automated pool cleaner, which is placed at the bottom of the pool. The automated pool cleaner may then be used in its normal manner for cleaning a swimming pool, and the adapter connecting the return line to the pool cleaner hose will prevent kinks or tangles during use.

The hose adapter 100 disclosed herein may be sold as a separate apparatus compatible with existing automated pool cleaners such that an existing cleaner can be retrofitted with the hose adapter 100. In another aspect, the hose adapter 100 may be a component of a pool cleaning system, as disclosed below.

One preferred embodiment of the present disclosure is directed to a system for cleaning pools. As shown in FIG. 7, the system comprises an automated pool cleaner 160, a pool cleaner hose 150 having a first end 151 and a second end 152, and a hose adapter 100 as disclosed herein. The automated pool cleaner 160 is configured to connect to one end of a pool cleaner hose 150 and to utilize a pool return line 170 for locomotion, suction, or both such that the cleaner 160 moves around the swimming pool cleaning the surfaces of the pool as it moves.

To utilize the system, the first end 151 of the pool cleaner hose 150 is attached to the automated pool cleaner 160, and the second end 152 of the pool cleaner hose 150 is attached to the hose adapter 100. The hose adapter 100 is attached to the outlet of a water return line 170 with the extension arm 120 extending upwardly, and the hose 150 is secured to the clamps 130 to maintain the hose 150 at an elevated position above the water return line 170, and preferably at or above the surface of the water. The pool's existing water circulation pump is activated to supply pressurized water to the system. Water flows through the return line outlet 170, the adapter 100, and the hose 150 to the automated pool cleaner 160, which is placed into the swimming pool. The cleanser 160 is then activated and utilizes the water pressure to provide suction for cleaning the surfaces of the pool. As the cleaner 160 moves around the pool, the elevated positioning of the hose 150 secured by the extension arm 120 will prevent the floating portion of the hose from being pushed back over a submerged portion of the hose during use, thereby reducing the occurrence of kinks or tangles in the pool cleaner hose during use.

It is understood that versions of the invention may come in different forms and embodiments. Additionally, it is understood that one of skill in the art would appreciate these various forms and embodiments as falling within the scope of the invention as disclosed herein.

What is claimed is:

1) A hose adapter comprising:
a fitting having a first end and a second end,
wherein the first end of the fitting is configured such that it can be attached to a return line of a pool and the second end of the fitting is configured such that it can be attached to a pool cleaner hose;
an extension arm attached to the fitting; and
a hose clamp attached to the extension arm,
wherein the extension arm and the hose clamp are configured to secure a portion of a pool cleaner hose in a position above a return line to which the fitting is attached during use.

2) The hose adapter of claim 1, wherein the fitting is an elbow fitting such that the second end of the fitting is positioned at an angle to the first end of the fitting.

3) The hose adapter of claim 1, wherein at least a portion of the extension arm is curved.

4) The hose adapter of claim 2, wherein at least a portion of the extension arm is curved in a direction opposite of the first end of the fitting.

5) The hose adapter of claim 1, wherein the extension arm has a first end and a second end, and the first end of the extension arm has a closed ring configured to fit around the exterior of the fitting.

6) The hose adapter of claim 5, further comprising a gasket positioned adjacent to the closed ring of the extension arm when the hose adapter is assembled.

7) The hose adapter of claim 1, wherein the fitting is made of polyvinyl chloride.

8) The hose adapter of claim 1, wherein the extension arm is made of stainless steel.

9) A system for cleaning a pool, said system comprising:
an automated pool cleaner;
a pool cleaner hose having a first end and a second end,
wherein the first end of the pool cleaner hose is configured such that it can be attached to the automated pool cleaner; and
a hose adapter comprising:
a fitting having a first end and a second end,
wherein the first end of the fitting is configured such that it can be attached to a return line of a pool and the second end of the fitting is configured such that it can be attached to the second end of the pool cleaner hose;
an extension arm attached to the fitting; and
a hose clamp attached to the extension arm,
wherein the extension arm and the hose clamp are configured to secure a portion of the pool cleaner hose in a position above a return line to which the fitting is attached during use.

10) The system of claim 9, wherein the fitting is an elbow fitting such that the second end of the fitting is positioned at an angle to the first end of the fitting.

11) The system of claim 9, wherein at least a portion of the extension arm is curved.

12) The system of claim 10, wherein at least a portion of the extension arm is curved in a direction opposite of the first end of the fitting.

13) The system of claim 9, wherein the extension arm of the hose adapter has a closed ring configured to fit around the exterior of the fitting.

14) The system of claim 13, wherein the hose adapter further comprises a gasket positioned adjacent to the closed ring of the extension arm when the hose adapter is assembled.

15) A method of cleaning a pool, said method comprising:
providing a hose adapter comprising:
a fitting having a first end and a second end,
wherein the first end of the fitting is configured such that it can be attached to a return line of a pool and the second end of the fitting is configured such that it can be attached to a pool cleaner hose;
an extension arm attached to the fitting; and
a hose clamp attached to the extension arm,
wherein the extension arm and the hose clamp are configured to secure a portion of a pool cleaner hose in a position above a return line to which the fitting is attached during use
providing an automated pool cleaner having one end of a pool cleaner hose attached thereto;
attaching the first end of the fitting to a return line of a swimming pool;
attaching the opposite end of the pool cleaner hose to the second end of the fitting;
securing a portion of the pool cleaner hose to the hose clamp in a position above the return line; and
initiating the automated pool cleaner to clean the pool.

16) The method of claim 15, wherein the fitting is an elbow fitting such that the second end of the fitting is positioned at an angle to the first end of the fitting.

17) The method of claim 15, wherein at least a portion of the extension arm is curved.

18) The method of claim 16, wherein at least a portion of the extension arm is curved in a direction opposite of the first end of the fitting.

19) The method of claim 15, wherein the extension arm has a closed ring configured to fit around the exterior of the fitting of the hose adapter.

20) The method of claim 19, wherein the hose adapter further comprises a gasket positioned adjacent to the closed ring of the extension arm when the hose adapter is assembled.
